(19) United States
(12) Patent Application Publication
(10) Pub. No.: US 2019/0384112 A1
(43) Pub. Date: Dec. 19, 2019

(54) DOUBLE-SIDED DISPLAY DEVICE AND DISPLAY MODULE THEREOF

(71) Applicant: Wuhan China Star Optoelectronics Technology Co., Ltd., Wuhan, Hubei (CN)

(72) Inventors: Yong YANG, Wuhan, Hubei (CN); Yingbao YANG, Wuhan, Hubei (CN)

(21) Appl. No.: 15/745,058

(22) PCT Filed: Dec. 5, 2017
(86) PCT No.: PCT/CN2017/114518

§ 371 Date: Jan. 15, 2018

(30) Foreign Application Priority Data
Nov. 30, 2017 (CN) 201711236910.X

(51) Int. Cl. G02F 1/1335; G09G 3/34

(52) U.S. Cl. CPC G02F 1/133603; G02F 1/133606; G09G 3/3426; G02F 1/133611; H04M 1/0202; G02F 2001/133626; G09G 2300/023; G09G 2310/0264; G02F 2001/133607

(57) ABSTRACT

The disclosure provides a double-sided display device and a display module thereof, the display module includes a backlight module, a first display surface, and a second display surface. The first display surface is a liquid crystal display panel, the backlight module is disposed between the first display surface and the second display surface, the backlight module includes a transparent substrate, a light source, and an optical film set, the light source is disposed on a surface of the transparent substrate facing the optical film set, and the optical film set is located between the light source and the first display surface. The display module proposed in the disclosure uses the backlight module as a light source of the first display surface and the second display surface so as to realize double-sided display characteristics of the liquid crystal display module and enhance the user experience.

### RELATED APPLICATIONS

The present application is a National Phase of International Application Number PCT/CN2017/114518, filed Dec. 5,2017, and claims the priority of China. Application No. 201711236910.X, filed Nov. 30, 2017.

### FIELD OF THE DISCLOSURE

The present invention relates to the field of double-sided display technology, and in particular to a double-sided display device and a display module thereof.

### BACKGROUND

Organic light emitting diode (OLED) panels are favored by the market due to their flexible and bendable characteristics. The characteristics also make OLED display technology the mainstream in dual-screen display. The dual-screen display not only increases the display area but also provides consumers with more comfort convenient experience. However, due to its own characteristics, liquid crystal device (LCD) display technology is seldom used in the field of dual-screen display. At present, there is no way to break through this limitation for LCD display technology in the market. Therefore, the LCD display technology cannot be compared with the OLED display technology in terms of dual-screen display and flexible display.

### SUMMARY

In order to solve the deficiencies of the prior art, the disclosure provides a double-sided display device and a display module thereof, which enables double-sided display in LCD modules to enhance user experience.

A specific technical proposal of this disclosure is to provide a display module, the display module includes a backlight module, a first display surface, and a second display surface, the first display surface is a liquid crystal display panel, the backlight module is disposed between the first display surface and the second display surface, the backlight module includes a transparent substrate, a light source, and an optical film set, the light source is disposed on a surface of the transparent substrate facing the optical film set, and the optical film set is located between the light source and the first display surface.

Further, a first driver circuit is further included, and the first driver circuit is configured to drive the first display surface to perform image display.

Further, the light source is a light emitting diode (LED) array, and the light emitting diode light emitting diode array includes a plurality of light emitting diodes arranged in a matrix.

Further, a number of the plurality of light emitting diodes on each row of the light emitting diode light emitting diode array and a number of the plurality of light emitting diodes on each column of the light emitting diode light emitting diode array are not less than 10.

Further, the second display surface is glass, and the display module further includes a second driver circuit configured to control an on/off switch of the plurality of light emitting diodes to present a black-and-white image on the second display surface.

Further, the optical film set includes a diffusion sheet and a first brightness enhancement film, and the diffusion sheet is disposed between the first brightness enhancement film and the light source.

Further, the backlight module further includes a second brightness enhancement film disposed between the transparent substrate and the second display surface.

Further, both the first brightness enhancement film and the second brightness enhancement film are prism sheets.

Further, the backlight module further includes a light guide plate, and the light guide plate is located between the light source and the optical film set.

The present invention also provides a double-sided display device, which includes the display module as described above.

The display module proposed in the disclosure includes a backlight module, a first display surface, and a second display surface. the first display surface is a liquid crystal display panel, the backlight module is disposed between the first display surface and the second display surface, and the backlight module is configured as a light source of the first display surface and the second display surface, so as to realize double-sided display characteristics of the liquid crystal display module and enhance the user experience.

### BRIEF DESCRIPTION OF THE DRAWINGS

FIG. 1 is a schematic structural view of a display module in Embodiment 1;

FIG. 2 is a schematic structural view of a backlight module in Embodiment 1;

FIG. 3 is a schematic structural view of a light emitting diode array in Embodiment 1;

FIG. 4 is a schematic circuit diagram of the display module in Embodiment 1;

FIG. 5 is a schematic structural view of a display module in Embodiment 2; and

FIG. 6 is a schematic structural diagram of a backlight module in Embodiment 2.

### DETAILED DESCRIPTION OF PREFERRED EMBODIMENTS

Hereinafter, embodiments of the disclosure will be described in detail with reference to the accompanying drawings. This disclosure may, however, be embodied in many different forms and should not be construed as limited to the embodiments set forth herein. Rather, these embodiments are provided to explain the principles of the disclosure and its practical application so as to enable those skilled in the art to understand the various embodiments of the disclosure and various modifications that are suitable for a specific intended application. In the drawings, the same reference numerals will always be used to indicate the same elements.

### Embodiment 1

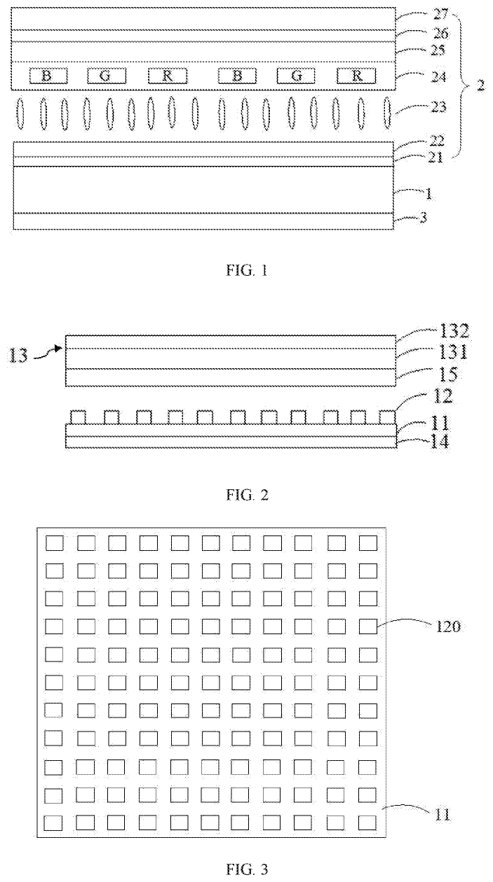

Referring to FIGS. 1 and 2, the display module in this embodiment includes a backlight module 1, a first display surface 2, and a second display surface 3. The first display surface 2 is a liquid crystal display panel. The backlight module 1 is disposed on the first display surface 2 and the second display surface 3. The backlight module 1 includes a transparent substrate 11, a light source 12, and an optical film set 13. The light source 12 is disposed on a surface of the substrate 11 facing the optical film set 13. The optical film set 13 is located between the light source 12 and the first display surface 2, a light emitted by the light source 12 toward the first display surface 2 is configured as a backlight of the first display surface 2, and a light emitted by the light source 12 toward the second display surface 3 provides a light source to the second display surface 3.

The backlight module 1 in this embodiment is a direct backlight module. The light emitted from the light source 12 toward the first display surface 2 enters the first display surface 2 through the optical film set 13, and the light emitted from the light source 12 toward the second display surface 3 enters the second display surface 2 through the transparent substrate 11; the backlight module 1 serves as both the backlight module of the first display surface 2 and the light source of the second display surface 3, so as to realize double-sided display characteristics of the liquid crystal display module and enhance the user experience. The material of the transparent substrate 11 is glass or sapphire.

The first display surface 2 includes a lower polarizer 21, a TFT array substrate 22, a liquid crystal layer 23, a CF substrate 24, an upper polarizer 25, a glue layer 26, and a cover plate 27. The cover plate 27 protects the first display surface 2 as the outermost layer of the first display surface 2, the liquid crystal layer 23 is located between the lower polarizer 21 and the cover plate 27, the TFT array substrate 22 is located between the liquid crystal layer 23 and the lower polarizer 21, the upper polarizer 25 is disposed between the liquid crystal layer 23 and the cover plate 27, the CF substrate 24 is disposed between the liquid crystal layer 23 and the upper polarizer 25, and the glue layer 26 is disposed between the upper polarizer 25 and the cover plate 27.

The optical film set 13 includes a diffusion sheet 131 and a first brightness enhancement film 132. The diffusion sheet 131 is disposed between the first brightness enhancement film 132 and the light source 12. The diffusion sheet 131 is configured to diffuse the light emitted by the light source 12, so that the light emitted by the light source 12 is evenly distributed in all viewing angles. The first brightness enhancement film 132 is configured to improve the contrast and brightness of the first display surface 2 in the direction of the normal viewing angle and increase the readability of the first display surface 2 in the direction of the normal viewing angle.

In order to improve the contrast and brightness of the second display surface 3 in the direction of the normal viewing angle, the backlight module further includes a second brightness enhancement film 14. The second brightness enhancement film 14 is disposed between the transparent substrate 11 and the second display surface 3. The first brightness enhancement film 132 and the second brightness enhancement film 14 are both prism sheets. The divergent light of the large viewing angle emitted by the light source 12 is converged and emitted within a smaller angle range after passing through the prism sheet, so as to increase the brightness of the first display surface 2 and the second display surfaces 3 in the direction of the normal viewing angle.

In order to further make the light emitted by the light source 12 evenly distributed in all directions of viewing angles, the backlight module 1 further includes a light guide plate 15, and the light guide plate 15 is located between the light source 12 and the optical film set 13. After the light emitted by the light source 12 passes through the light guide plate 15, the light is uniformly emitted from a light output surface of the light guide plate 15.

Referring to FIG. 3, the light source 12 in this embodiment is a light emitting diode light emitting diode array, and the light emitting diode light emitting diode array includes a plurality of light emitting diodes 120 arranged in a matrix. Since the backlight module 1 in this embodiment is of the direct type, in order not to affect the display effect of the first display surface 2, the number of the plurality of light emitting diodes 120 on each row of the light emitting diode array, and the number of the plurality of light emitting diodes 120 on each column of the light emitting diode array are not less than 10, that is, the light emitting diode light emitting diode array is at least 10×10 array. Of course, the size of the light emitting diode light emitting diode array can be set according to the actual needs of the first display surface 2, which is not limited herein.

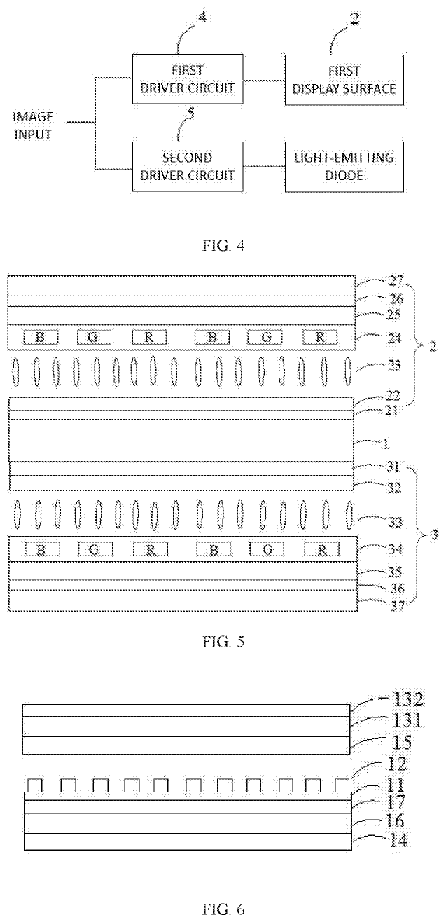

Referring to FIG. 4, the display module in this embodiment includes a first driver circuit 4 configured to drive the first display surface 2 to perform display. Specifically, the first driver circuit 4 is configured to control the brightness of the light source 12 and the deflection of the liquid crystal molecules in the liquid crystal layer 23 to perform image display.

The second display surface 3 is a transparent panel. For example, the second display surface 3 is a glass panel. The display module further includes a second driver circuit 5, and the second driver circuit 5 is configured to control the light and dark of the plurality of light emitting diodes 120 to present a simple black and white image on the second display surface 3. Specifically, the second driver circuit 5 includes a plurality of driving electrodes, each of the plurality of driving electrodes has a one-to-one correspondence with the plurality of light emitting diodes 120, and the driving electrodes may be thin film transistor arrays. One light emitting diode 120 in the light emitting diode light emitting diode array is a pixel of a black and white image on the second display surface 3. By controlling the lighting state of each of the plurality of light emitting diodes 120 by the driving electrode, the display of each pixel to display can be controlled to present a black and white image on the second display face 3. For example, in the white display area, the plurality of light emitting diode 120 corresponding to the pixel is controlled to bright, and the white is displayed; in the black display area, the plurality of light emitting diode 120 corresponding to the pixel in the area is controlled to be dark and the black is displayed.

In this embodiment, part of the plurality of light emitting diodes 120 can be selected from the light emitting diode light emitting diode array as the pixels of the black and white image when the black and white image is displayed. Of course, the more the number of the plurality of light emitting diodes 120 is selected, the higher the resolution of the black and white image is. The arrangement of the plurality of light emitting diodes 120 which are the pixels of the black and white image is not limited to the matrix form, and may also be other arrangements, such as diamonds, triangles, and other arrangements, which are not limited herein.

The embodiment further provides a double-sided display device, including the display module, and the double-sided display device performs double-sided display by adopting the display module. The double-sided display device may be an electronic device such as a mobile phone, a tablet computer, a notebook computer, a monitor or the like.

Taking the double-side display device as a mobile phone as an example, the first display surface 2 is located on the front of the mobile phone and the second display surface 3 is located on the back of the mobile phone. When the mobile phone is in the normal working mode, the first display surface 2 is driven by the first driver circuit 4 to display the picture of the mobile phone. In this case, the brightness of the light source 12 is high and the power consumption of the entire mobile phone is large. When the mobile phone is in the standby mode, that is, the first display surface 2 is not displayed, when the mobile phone receives the prompt message such as short message, email or the like, the message may be prompted through the second display surface 3 and the brightness and darkness of the plurality of light emitting diodes 120 are controlled by the second driver circuit 5 to prompt messages such as short messages and emails; In this case, the brightness of the light source 12 is low and the power consumption of the entire mobile phone is low so as to avoid the poor ability of the mobile phone to endure frequent opening and closing of the first display surface 2, thereby realizing the double-sided display while reducing the power consumption of the entire mobile phone and enhancing the battery life and user experience.

### Embodiment 2

The second display surface 3 in this embodiment is also a liquid crystal display panel.

Referring to FIGS. 5 and 6, specifically, the backlight module 1 further includes a diffusion sheet 16 disposed and a light guide plate 17 both between the transparent substrate 11 and the second brightness enhancement film 14, and the light guide plate 17 is located between the transparent substrate 11 and the diffusion sheet 16. The second display surface 3 includes a lower polarizer 31, a TFT array substrate 32, a liquid crystal layer 33, a CF substrate 34, an upper polarizer 35, a glue layer 36, and a cover plate 37. The cover plate 37 protects the second display surface 3 as the outermost layer of the second display surface 3. The liquid crystal layer 33 is located between the lower polarizer 31 and the cover plate 37, the TFT array substrate 32 is located between the liquid crystal layer 33 and the lower polarizer 31, the upper polarizer 35 is disposed between the liquid crystal layer 33 and the cover 37, the CF substrate 34 is disposed between the liquid crystal layer 33 and the upper polarizer 35, and the glue layer 36 is disposed between the upper polarizer 35 and the cover 37. The light emitted from the light source 12 toward the first display surface 2 is configured as the backlight of the first display surface 2 and the light emitted from the light source 12 toward the second display surface 3 is configured as the backlight of the second display surface 3.

In this embodiment, both the first display surface 2 and the second display surface 3 can display a color image, and the first display surface 2 and the second display surface 3 are respectively driven by the first driver circuit 4 and the second driver circuit 5 to perform the different images. Certainly, the first display surface 2 and the second display surface 3 in this embodiment can display the same image by the same driver circuit.

It should be indicated that the present application can also be improved and modified by those skilled in the art without departing from the principle of the present application, and these improvements and modifications also fall within the protection scope of the claims of the present application. What is claimed is:

1. A display module, comprising:
a backlight module;
a first display surface; and
a second display surface;
wherein the first display surface is a liquid crystal display panel, the backlight module is disposed between the first display surface and the second display surface;
wherein the backlight module comprises a transparent substrate, a light source, and an optical film set, the light source is disposed on a surface of the transparent substrate facing the optical film set, and the optical film set is located between the light source and the first display surface.

2. The display module according to claim 1, further comprising a first driver circuit, wherein the first driver circuit is configured to drive the first display surface to perform image display.

3. The display module according to claim 2, wherein the light source is a light emitting diode array, and the light emitting diode array comprises a plurality of light emitting diodes arranged in a matrix.

4. The display module according to claim 3, wherein a number of the light emitting diodes in each row of the light emitting diode array and a number of the light emitting diodes in each column of the light emitting diode array are not less than 10.

5. The display module according to claim 3, wherein the second display surface is a transparent panel, the display module further comprises a second driver circuit configured to control an on/off switch of the plurality of light emitting diodes to present a black-and-white image on the second display surface.

6. The display module according to claim 1, wherein the optical film set comprises a diffusion sheet and a first brightness enhancement film, and the diffusion sheet is disposed between the first brightness enhancement film and the light source.

7. The display module of claim 6, wherein the backlight module further comprises a second brightness enhancement film disposed between the transparent substrate and the second display surface.

8. The display module of claim 7, wherein the first brightness enhancement film and the second brightness enhancement film are both prism sheets.

9. The display module according to claim 1, wherein the backlight module further comprises a light guide plate, and the light guide plate is located between the light source and the optical film set.

10. A double-sided display device, comprising:
a display module;
wherein the display module comprises a backlight module, a first display surface, and a second display surface;
wherein the first display surface is a liquid crystal display panel, the backlight module is disposed between the first display surface and the second display surface, wherein the backlight module comprises a transparent substrate, a light source, and an optical film set, the light source is disposed on a surface of the transparent substrate facing the optical film set, and the optical film set is located between the light source and the first display surface.

11. The double-sided display device according to claim 10, further comprising a first driver circuit, wherein the first driver circuit is configured to drive the first display surface to perform image display.

12. The double-sided display device of claim 11, wherein the light source is a light emitting diode array, and the light emitting diode array comprises a plurality of light emitting diodes arranged in a matrix.

13. The double-sided display device of claim 12, wherein a number of the plurality of light emitting diodes on each row of the light emitting diode array and a number of the plurality of light emitting diodes on each column of the light emitting diode array are not less than 10.

14. The double-sided display device according to claim 12, wherein the second display surface is a transparent panel, the display module further comprises a second driver circuit configured to control an on/off switch of the plurality of light emitting diodes to present a black and white image on the second display surface.

15. The double-sided display device according to claim 10, wherein the optical film set comprises a diffusion sheet and a first brightness enhancement film, and the diffusion sheet is disposed between the first brightness enhancement film and the light source.

16. The double-sided display device according to claim 15, wherein the backlight module further comprises a second brightness enhancement film disposed between the transparent substrate and the second display surface.

17. The double-sided display according to claim 16, wherein the first brightness enhancement film and the second brightness enhancement film are both prism sheets.

18. The double-sided display device according to claim 10, wherein the backlight module further comprises a light guide plate, and the light guide plate is located between the light source and the optical film set.
